(19) United States
(12) Patent Application Publication
(10) Pub. No.: US 2014/0358710 A1
(43) Pub. Date: Dec. 4, 2014

(54) MARKET FOR RESOURCES BASED ON REUSABLE USAGE POINTS AND USAGE PERIODS

(71) Applicant: Hewlett-Packard Development Company, L.P., Houston, TX (US)

(72) Inventors: Filippo Balestrieri, Palo Alto, CA (US); Christina Aperjis, Palo Alto, CA (US); Bernardo Huberman, Palo Alto, CA (US)

(21) Appl. No.: 13/907,509

(22) Filed: May 31, 2013

(51) Int. Cl. G06Q 30/06

(52) U.S. Cl. CPC G06Q 30/0601
USPC 705/26.1

(57) ABSTRACT

Example embodiments relate to a resource market based on reusable usage points and usage periods. In some examples, a system may maintain multiple resources provided by at least one resource provider, each resource being conditionally accessible by a user. The system may maintain multiple types of usage periods, each different usage period type specifying a different duration. The system may maintain multiple types of usage points, the usage point types being respectively associated with the usage period types. The system may allow the user to access a first resource of the multiple resources during a particular usage period by allocating a number of usage points to the first resource. The usage may be allowed based on the usage period being of a first usage period type and the number of usage points each being of an associated first usage point type.

### BACKGROUND

As data centers and cloud computing become more prevalent, entities are providing various resources to users via such data centers and/or clouds. The term “data center” may refer to a facility used to house computing resources such as computing devices and associated components (e.g., communication components, storage systems and the like). The term “cloud” may refer to computing resources provided by at least one data center that are offered together to users as a unified service. Using such a data center and/or cloud, an entity may provide resources to users such as applications (e.g., software as a service or “SAS”), services, operating systems (e.g., platform as a service or “PAS”), raw computing and/or storage resources (e.g., infrastructure as a service or “IAS”), digital content (e.g., digital music, movies, etc.) and the like.

### BRIEF DESCRIPTION OF THE DRAWINGS

The following detailed description references the drawings, wherein:

FIG. 1 is a block diagram of an example network setup, where a market for resources based on reusable usage points and usage periods may be used in such a network setup;

FIG. 2A depicts a diagram of how an example resource market system may work, specifically from a user's point of view;

FIG. 2B depicts a diagram of how an example resource market system may work, specifically from a user's point of view;

FIG. 3A depicts a diagram of how an example resource market system may work, specifically from a provider's point of view;

FIG. 3B depicts a diagram of how an example resource market system may work, specifically from a provider's point of view;

FIG. 4 is a block diagram of an example content market service for providing resources based on reusable usage points and usage periods;

FIG. 5 is a flowchart of an example method for providing resources based on reusable usage points and usage periods;

FIG. 6 is a block diagram of an example resource market computing device for implementing a resource market based on reusable usage points and usage periods; and

FIG. 7 is a flowchart of an example method for providing resources based on reusable usage points and usage periods.

### DETAILED DESCRIPTION

As described above, an entity may provide (e.g., via a data center or cloud) resources to users such as applications (e.g., software as a service or “SAS”), services, operating systems (e.g., platform as a service or “PAS”), raw computing and/or storage resources (e.g., infrastructure as a service or “IAS”), digital content (e.g., digital music, movies, etc.) and the like. In some scenarios, an entity may maintain (e.g., as part of the data center or cloud) a service that allows users to search, browse and/or view resources, select resources, pay for resources and access resources. One example of such a service is a mobile application store that allows users to search, browse and/or view mobile applications. Users can then select certain applications, pay for them, and then access the applications, for example, to download them.

Various services that allow users to access resources (e.g., mobile applications) facilitate a one-time purchase transaction between the user and the service, for example, where the user pays money to the service and the service then provides the resource to the user. The user may then own the resource and may use it forever, for example. The service may also pay some or all of the money paid by the user to the provider of the resource (e.g., if the provider is different than the entity that maintains the service). Various other services implement a license-based model, for example, where the user pays money to the service for the right to use a resource for a fixed period of time. In such implementations, the transaction to purchase a license for a period of time is still a one-time transaction, and the user (absent some trial period or malfunction of the resource) may not change his or her mind and switch to a different resource during the duration of the license. In other words, in both the case of the purchase and the license, once the one-time transaction has occurred, the transaction is final. Various services may allow a single provider to offer a “pool” of resources from which a user may select a resource to spend the user's money on. However, the pool includes resources from a single provider, and again, once the selection (i.e., the transaction) has occurred, the transaction is final. Various services may allow a user to purchase points (e.g., with dollars or other currency), and then the points may be used to purchase or license resources. With such services, when the points are exchanged for the resource the exchange is again final. In other words, in these scenarios, regardless of whether currency or points are used to purchase or license resources, the currency or points are expended or “lost” once the transaction is complete. Then later, to purchase or license additional or different resources, additional currency or points must be used.

The present disclosure describes a market for resources based on reusable usage points and usage periods. The market may allow users to purchase usage points, for example, usage points of various types, where each point type is associated with a particular type of usage period. The term “usage point” (or simply, “point”), throughout this disclosure, may refer to reusable points or tokens that may be exchanged (e.g., temporarily) for use of a resource. The term “usage period” may be used generally herein to refer to periods of time against which the usage of various resources may be monitored and/or against which the usability of points may be measured. The type of a usage period may indicate the duration of the usage period. The market may allow users to assign and/or associate each point with a particular usage period, for example, a usage period of a type that is related to the type of the point. The usage period associated with a point may determine the start date of the point and an expiration date for the point. The market may allow users to allocate, de-allocate and reallocate their points to different resources provided by the market during the duration of the usage period to which the points are associated. If a user stops using a particular resource (e.g., before the end of the associated usage period), points previously allocated to that resource may be de-allocated and may then become available to the user to allocate to other resources provided by the market. The market may allow resource providers to provide resources to be used by users. The market may monitor usage of resources by users (for example, at various granularities), and may pay resource providers for such usage. Throughout this disclosure, the term “resource” may be used to refer to resources provided to users via a market, resources such as applications (e.g., software as a service or “SAS”), services, operating systems (e.g., platform as a service or “PAS”), raw computing and/or storage resources (e.g., infrastructure as a service or “IAS”), digital content (e.g., digital music, movies, audio, video, etc.) and the like.

As it may be described in more detail below, the market of the present disclosure may allow for decoupling between various time periods, for example, the time period during which the user is committed to pay (e.g., in currency or points) for usage of resources and the time period during which a user is committed to usage of a particular resource. As another example, the market may allow for decoupling between the time period during which the user is committed to pay (e.g., in currency or points) for usage of resources and the time period for which a resource provider is paid for usage of a particular resource. Such decoupling may provide benefits over various other services (e.g., those described above).

The present disclosure may provide flexibility to both users and resource providers. For users, the market as described herein may allow a user to use various resources during a particular usage period, while only requiring the user to pay once, for example. Users may be allowed to pay for general usage (e.g., during a usage period) of resources up front, and then may be allowed to explore various resources during the usage period. This may allow a user to avoid the hesitation of committing to resources because of uncertainty regarding features and capabilities, and instead may allow a user to learn about the features and capabilities of resources before using the resources for a long term. This flexibility may be especially useful in the case of enterprise resources (e.g., enterprise applications and raw computing and/or storage resources). Enterprise resources are generally very complex and expensive, and may need significant maintenance. With various other services that provide resources (e.g., those discussed above), a user may hesitate to sink such a cost into an enterprise resource unless the user knows with a high degree of certainty that the resource works well and will get significant use. The present disclosure allows a user to proceed with minimal hesitation or without hesitation, for example, because the market may provide the user with many resource options.

Also for users, the present disclosure minimizes the number of transactions that are required between the user and individual resource providers. The user may purchase a number of usage points with a single transaction and then switch between using various resources with a simple selection. Another benefit to users may be that the market described herein allows users flexibility of use (described above) while still allowing users to adhere to budgeting periods, for example, as many companies must do. For example, a company may have to commit to an “enterprise software” budget for a fiscal quarter, year or the like. The market described herein may allow for such a commitment while still allowing the company flexibility with the resources it uses throughout the quarter, year or the like. Also for users, the present disclosure incentivizes and encourages innovative and quality resources by the resource providers. Because resource providers know that users may switch which resources they use at essentially any time, the providers may increase their efforts to deliver quality and innovated resources in order to gain and/or maintain business.

For resource providers, the present disclosure provides various benefits, for example, access to a large number of potential users. Developing or providing a resource may be costly, especially in the case of enterprise resources, as explained above. In addition to the reasons provided above, enterprise resources may require the provider to frequently update the resources based on customer requirements and/or industry standard requirements. Additionally, some resource providers may not have significant name recognition, reputation or good will. These factors may make it hard for some resource providers to break into a market, especially a market with large commercial customers, high transaction and/or negotiation costs and high entrance barriers like enterprise resources. The present disclosure may allow a resource provider to easily access many users (e.g., large enterprise customers), which may increase the expected return on the potentially costly investment of developing/providing a resource. Additionally, because the market may reduce or remove the hesitation of users to use the resources of the market (as explained above), a provider may secure customers, e.g., even without significant name recognition. As a consequence, more users may provide resources to the market and users may have access to a larger selection of resources. Additionally, the present disclosure may spur innovation among resource providers, first of all, because more resource providers are able to enter the market (e.g., higher expected return on investment), and secondly, because resource providers may see resources provided by other providers and may see ratings, reviews and/or usage statistics (more information provided below) of these other resources. Seeing successful and quality resources may incentivize providers to come up with similar, add-on or follow-up resources that are better, targeted toward a slightly different use, and the like.

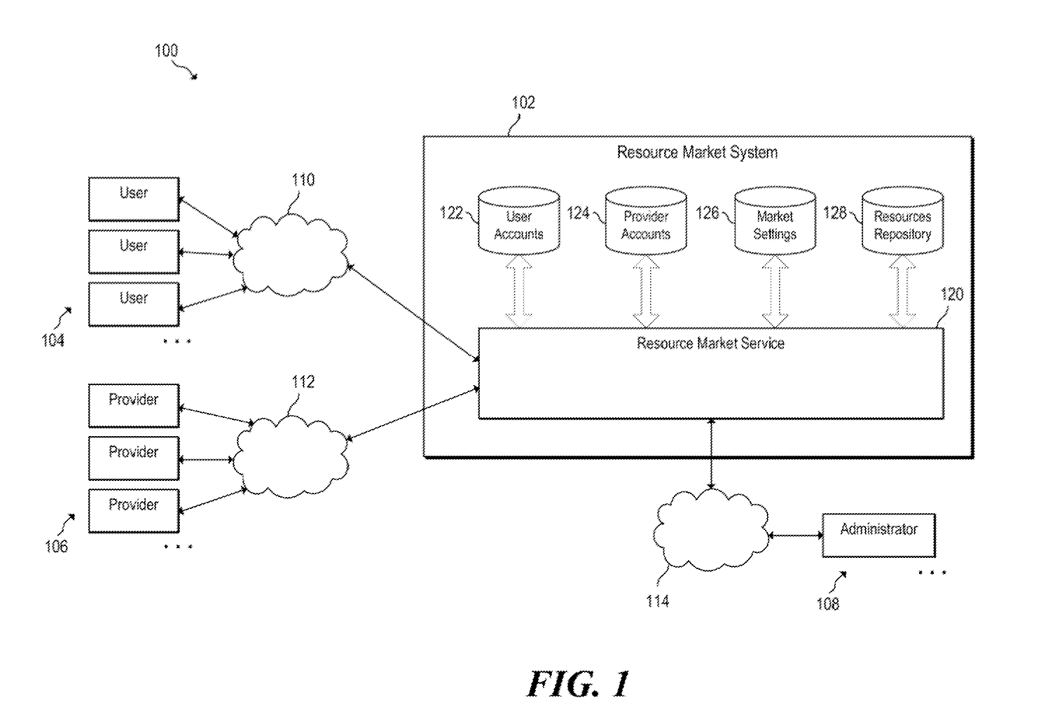

FIG. 1 is a block diagram of an example network setup 100, where a market for resources based on reusable usage points and usage periods may be used in such a network setup. Network setup 100 may include a resource market system 102, as described in more detail below. Network setup 100 may include a number of users 104, which may be in communication with resource market system 102, for example, via a network 110. Users 104 may communicate with resource market system 102 (e.g., with resource market service 120) to, among other things, access various resources provided by the resource market system 102, as described in more detail herein. Network setup 100 may include a number of providers 106, which may be in communication with resource market system 102, for example, via a network 112. Providers 106 may communicate with resource market system 102 (e.g., with resource market service 120) to, among other things, provide various resources to the resource market system 102, as described in more detail herein. Network setup 100 may include a number of administrators 108 (or simply “admins”), which may be in communication with resource market system 102, for example, via a network 114. Admins 108 may communicate with resource market system 102 (e.g., with resource market service 120) to, among other things, configure the resource market system 102, as described in more detail below. Networks 110, 112, 114 may be wired or wireless networks, and may include any number of hubs, routers, switches or the like. Networks 110, 112, 114 may be, for example, part of the internet, at least one intranet and/or other type(s) of network(s). In some embodiments, two or more of networks 110, 112, 114 may be the same network.

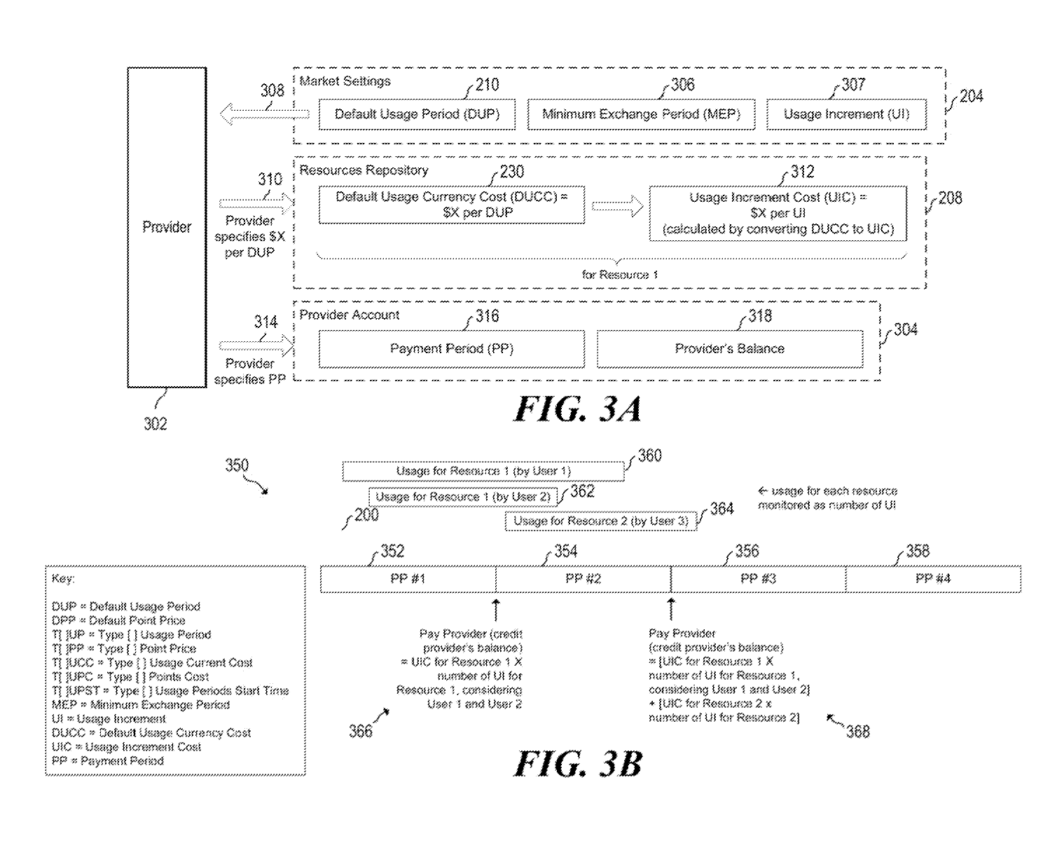

Resource market system 102 may include a resource market service 120. Resource market service 120 may maintain and provide resources based on reusable usage points and usage periods, as described in more detail below. Resource market service 120 may be implemented as at least one computing device, for example, any computing device accessible to users and providers over the Internet or some other network. In some embodiments, resource market service 120 may be implemented as more than one computing device, for example, computing devices that are in communication with each other (e.g., via a network). In these embodiments, the computing devices may be separate devices, perhaps geographically separate. The term “system” and/or “service” may be used to refer to a computing environment that includes one computing device or more than one computing device. It may be said that the resource market system 102 and/or the resource market service 120 may be offered in the “cloud” or as a cloud service, for example, because the system and/or service is provided by a number of computing devices and related components that are in communication with each other and presented as a unified service. More details of an example resource market service may be described below with regard to FIG. 4.

Resource market system 102 may include a number of repositories, for example, repositories 122, 124, 126, 128. The term repository may generally refer to a data store that may store digital information. Each of these repositories may include or be in communication with at least one physical storage mechanism (e.g., hard drive, solid state drive, tap drive or the like) capable of storing information including, for example, a digital database, a file capable of storing text, applications, media, code, settings or the like, or other type of data store. Repositories 122, 124, 126, 128 may be in communication (e.g., directly or via a network) with resource market service 120. In alternate embodiments, repositories 122, 124, 126, 128 may be included within resource market service 120. In some situations, two or more of the repositories 122, 124, 126, 128 may be implemented as the same single repository. In some situations, at least one of the repositories 122, 124, 126, 128 may be implemented as multiple repositories. User account repository 122 may store, for each user, various settings and pieces of information for the user. Provider account repository 122 may store, for each provider, various settings and pieces of information for the provider. Market settings repository 126 may store various settings and values that may be used by the resource market system. Resources repository 128 may store resources (e.g., software applications), information used to access resources, information related to particular resources, and the like.

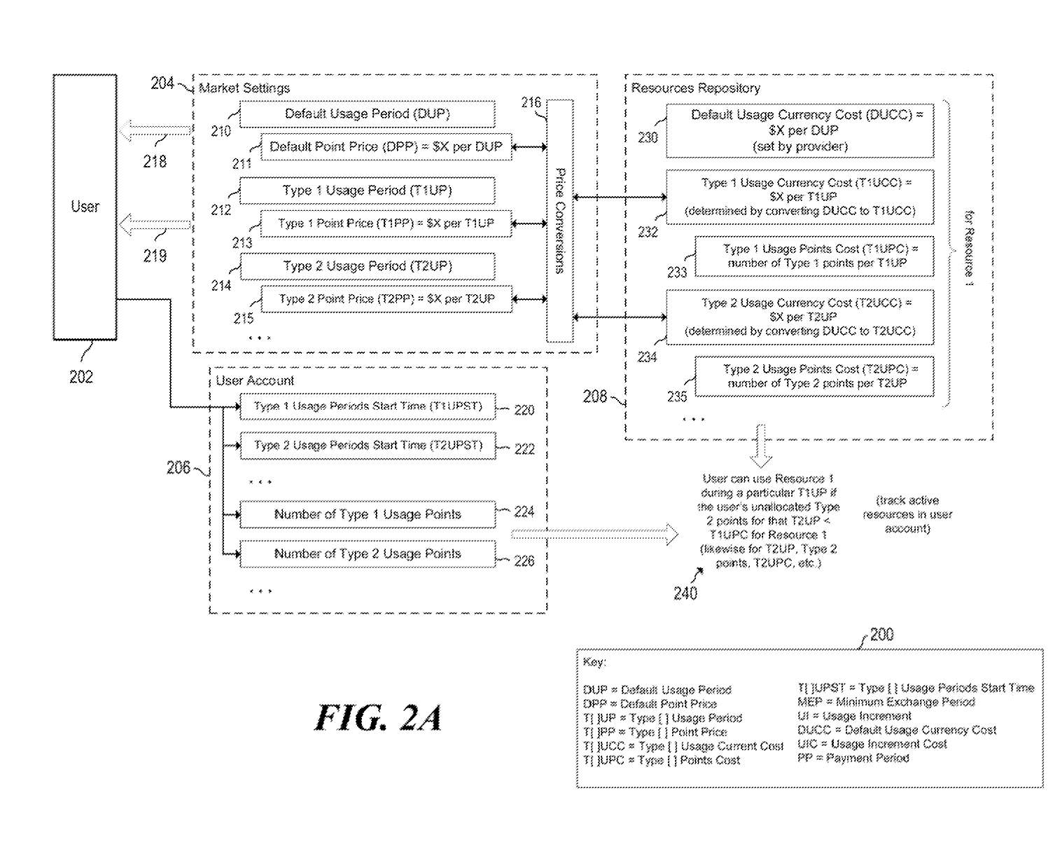

FIGS. 2A and 2B depict diagrams of how an example resource market system (e.g., 102) may work. Specifically, FIGS. 2A and 2B may depict how such a system may work from a user's point of view. To aid in providing an easy to understand description, FIGS. 2A and 2B each include a key 200 that shows abbreviations for various terms. These terms will be defined in various descriptions provided below.

FIG. 2A depicts an example user 202 (e.g., similar to users 104 of FIG. 1). User 202 may be an individual, for example, acting on behalf of an entity such as a company. User 202 may be interested in paying a determined up-front price to use various resources provided by a resource market system (e.g., 102) during at least one usage period, while having the flexibility to vary which resources are used during the usage period(s). FIG. 2A depicts various boxes that represent values, settings and the like that are maintained by the resource market system. Some of these boxes (e.g., 210, 211, 212, 213, 214, 215, 216) are depicted inside of dotted box 204 (entitled, “Market Settings”), which may indicate that these boxes are maintained in a market settings repository (e.g., 126). Some of these boxes (e.g., 220, 222, 224, 226) are depicted inside of dotted box 206 (entitled, “User Account”), which may indicate that these boxes are maintained in a user account repository (e.g., 122). Some of these boxes (e.g., 230, 232, 233, 234, 235) are depicted inside of dotted box 208 (entitled, “Resources Repository”), which may indicate that these boxes are maintained in a resources repository (e.g., 128).

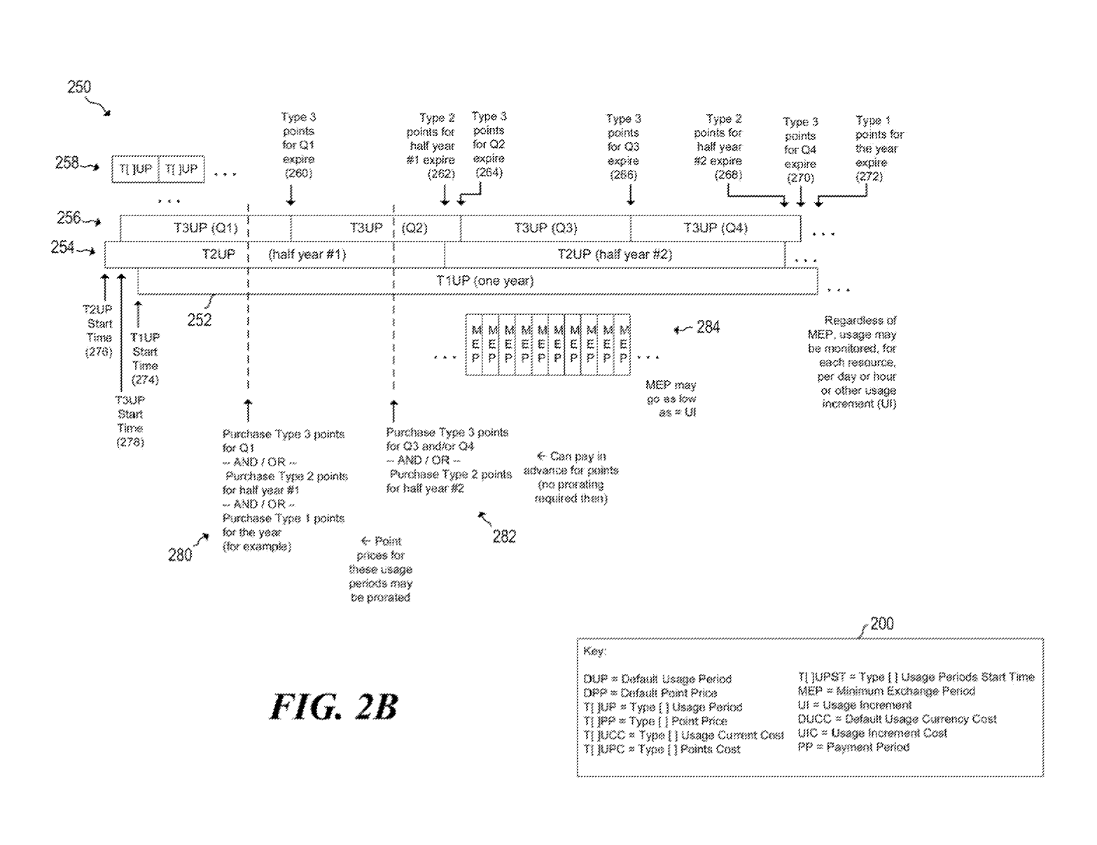

As shown in FIG. 2A, a market settings repository (e.g., indicated by dotted box 204) may maintain, among other values and/or settings, a default usage period (DUP) 210, a default point price (DPP) 211, a type [ ] Usage Period (T[ ]UP) for each type of point (e.g., 212, 214), and a type [ ] point price (T[ ]PP) for each type of point (e.g., 213, 215). It should be understood that the symbol ‘[ ]’ as used in this disclosure and in the figures may represent a variable where the symbol may be replaced with an indicator of a particular type of point and/or usage period (e.g., 1, 2, 3, etc. or A, B, C, etc. or the like). The market settings repository may also maintain price conversions 216. The values and/or settings in the market settings repository may be set by a system administrator (e.g., 108) and may be values that are fixed (e.g., until changed by an admin) for all users and providers. It should be understood that while an admin may be able to change certain values at any time, new values may only effect new transactions/contracts (e.g., new purchases of points) between users and the resource market system. Other values and/or settings maintained in the market settings repository may be described below with regard to FIG. 3A.

As shown in FIG. 2A, a user account repository (e.g., indicated by dotted box 206) may maintain for each user, among other values and/or settings, a type [ ] usage periods start time (T[ ]UPST) for each type of point (e.g., 220, 222), and a count or number of points for each type of point (e.g., 224, 226). In some examples, as described more below, user account repository 206 may maintain multiple type [ ] usage period start times for each type of point, which may be used to implement usage periods (of a certain type) that are not arranged back-to-back. These values and/or settings, for a particular user (e.g., 104) may be set by the user and may be altered from time to time, perhaps with limitations on when and how the values and/or settings may be altered. As shown in FIG. 2A, a resources repository (e.g., indicated by dotted box 208) may maintain for each resource provided by the market, among other values and/or settings, a default usage currency cost (DUCC) 230, a type [ ] usage currency cost (T[ ]UCC) for each type of point (e.g., 232, 234), and a type [ ] usage points cost (T[ ]UPC) for each type of point (e.g., 233, 235). DUCC 230, for a particular resource, may be set by the provider of the resource. The other values and/or settings (e.g., 232, 233, 234, 235), for a particular resource, may be set by the system and may be, for example, based on DUCC 230 and perhaps one or more price conversions 216 maintained in market settings repository 204.

Default usage period (DUP) 210 may serve as a benchmark time period for various purposes in the resource market system. For example, a default point price (DPP 211) may be set (e.g., by an administrator) in relation to the DUP 210. As another example, the usage cost (DUCC 230) for a particular resource may be set (e.g., by a provider) in relation to the DUP (see FIG. 3A for more details). Default point price (DPP) 211 may be the price that an administrator sets with respect to the DUP 210. The DUP may be the same for all users and providers, and admins may set the default point price (DPP) with respect to a common benchmark (DUP). Additionally, the DPP and DUP may allow users (e.g., user 202) to compare (e.g., see reference number 218), via a fixed benchmark, fluctuations in the general price of a point, even if the users actually purchase different types of points (e.g., Type 1, Type 2, etc.), as described in more detail below.

The resource market system may support multiple types of usage periods, generally denoted by “type [ ] usage period” or T[ ]UP. For example, FIG. 2A shows a type 1 usage period 212 and a type 2 usage period 214. The resource market may support more or less types (e.g., type 3, 4, etc.). The available types of usage periods may be determined by the system (e.g., with input from an admin) and may be maintained in the market settings repository 204. Each type of usage period may be characterized by a different duration of time. The duration of time for each usage period may be set by the system. The different types of usage periods may be set to conform to periods of time commonly used in business or elsewhere, for example, budgetary or fiscal periods of time. As one example, a first type of usage period (e.g., T1UP 212) may have a duration of one year, and a second type of usage period (e.g., T2UP 214) may have a duration of one half year. Many other types of usage periods may be used, for example, usage periods with durations of one quarter (i.e., quarter year), two quarters, one week, one month and the like.

The resource market system may allow a user to purchase usage points. The system may support multiple types of usage points, where the types of usage points may be related to and be associated with the types of usage periods (e.g., described above). For example, a first type of usage point may be exchangeable for usage of a resource during a first type of usage period (e.g., a usage period with a duration of one year). A second type of usage point may be exchangeable for usage of a resource during a second type of usage period (e.g., a usage period with a duration of one half year). Many other types of usage points may be used to align with many other types of usage periods (e.g., with durations of one quarter, two quarters, one week, one month and the like).

It should be understood that the term usage period, throughout this disclosure, may be used in a flexible manner to refer to, depending on the context, either a usage period setting (e.g., 210, 212, 214) or time periods of potential resource use (e.g., T1UP 252, T2UP's 254, T3UP's 256) that conform to the usage period setting. For a particular user, usage periods of a particular type (e.g., type1, type2 and/or type 3 in FIG. 2B) may be arranged in a consecutive, back-to-back manner. In this respect, for a usage period of the particular type, the T[ ]UPST setting may determine when the first usage period of the type starts, and once that usage period expires, the next usage period of the same type may start automatically.

In some embodiments, usage periods may not be arranged in a back-to-back manner. This may be particularly useful for shorter duration usage periods (e.g., 1 week). In these embodiments, for usage periods of a particular type, usage periods may start at various times that may not align with the end of a previous usage period. Thus, a T[ ]UPST setting may be maintained for each individual usage period. In this respect, usage periods of a particular type may be arranged such that time periods may exist between usage periods. Additionally, one usage period may overlap with another usage period of the same type. In these examples, users may have the ability to add as many usage periods as they like of a particular type by adding additional T[ ]UPST settings of that type to their user account.

FIG. 2B shows a time diagram 250 (e.g., for a particular user 202) that includes multiple usage periods of multiple types. The time diagram 250 may be oriented on an imaginary x-axis that represents time, such that, from the left of the time diagram to the right of the time diagram, time ticks by. For example, FIG. 2B shows a single T1UP 252 with a duration of one year. As indicated in FIG. 2B, additional T1UP's may come after T1UP 252, for example, in a consecutive, back-to-back manner. In other examples, usage periods may not be arranged in a back-to-back manner. T1UP 252 and additional T1UP's may each conform to a T1UP setting (e.g., 212), which may determine the length of the T1UP's, for example. As another example, FIG. 2B shows two T2UP's 254, each with a duration of one half year. As indicated in FIG. 2B, additional T2UP's may come after T2UP's 254, for example, in a consecutive, back-to-back manner. In other examples, usage periods may not be arranged in a back-to-back manner. T2UP's 254 and additional T2UP's may each conform to a T2UP setting (e.g., 214), which may determine the length of the T2UP's, for example. Other usage periods of other types (e.g., T3UP's 256 and any other type of usage periods, indicated by T[ ]UP's 258) may behave in a similar manner.

For points of a particular type, the user may assign each point (or group of points) of the type to a particular usage period of the same type. Then, during the particular usage period, the user may use the points to exchange for usage of resources. Referring to FIG. 28, a user may purchase, for example, a number of type 3 usage points, which may allow the user to exchange the type 3 usage points for usage of at least one resource during at least one of the T3UP's 256. Regarding a particular example type 3 usage point, the user may pay for the type 3 usage point, and then may assign the usage point to a particular T3UP, for example, Q2. Then, this usage point is associated with the Q2 T3UP, which means that the user can only exchange the usage point for usage of a resource during the Q2 T3UP, and at the end of the Q2 T3UP, the usage point may expire and/or become unusable and/or disappear.

The resource market system may allow a user to specify the start time (e.g., date and/or time) of the usage periods of each type, for example, by specifying a setting (e.g., T[ ]UPST), for each usage period type, in user account 206. FIG. 2A shows, in user account 206, a type 1 usage periods start time (T1UPST) 220 and a type 2 usage periods start time (T2UPST) 222. The user associated with the particular user account may set these usage periods start times. FIG. 2B may show how the various start times for different types of usage periods may work. For example, it can be seen that, at reference number 274, T1UP 252 for the year starts at the indicated time, at reference number 276, T2UP's 254 start at the indicated time, and at reference number 278, T3UP's 256 start at the indicated time. Thus, different types of usage periods may start at different times, for example, as configured by the user. In some situations, the resource market system may impose limitations on the user's ability to set usage periods start times. For example, the system may limit the granularity with which the user may specify the start times (e.g., increments of one day). In some situations, the resource market may set the start times instead of the user.

As mentioned above, usage periods may not be arranged in a back-to-back manner. Thus, in the example of FIG. 2B, space (i.e., time) may exist between usage periods of the same type (e.g., between T2UP's 254 and T3UP's 256) depending on the start times of the particular usage periods. Also, usage periods of the same type may overlap. For example, if the start time of one usage period is earlier in time than the expiration of another usage period.

Purchased usage points may be assigned to a particular usage period either at the time of purchase, or after the purchase. Assigning a point to a usage period in effect establishes a start date for the usage point. Once a point is assigned to a usage period, the start of the usage period (and the start date of the point) may be fixed, and may be unable to be changed by a user. Assigning a point to a usage period may also be thought of as “activating” the point. Thus, purchased points may remain inactive before the user associates them with a usage period. In the examples where particular usage periods of a certain type may be arranged in a non-back-to-back manner, a user may specify the start time of a particular point, e.g., by assigning the point to a particular usage period with a designated start time. The start time of a point may be specified at or after the time of purchase of the point and before the absolute expiration time of the point. For example, a user may purchase points of type 1 and then specify a start time for the points by designating a start time of a particular usage period of the same type and assigning the type 1 points to that usage period, thereby activating the points. Alternatively, the start time for a usage period may be specified before the points are purchased. In this respect, a user may have flexibility to create usage periods that accommodate various needs of the user.

In general, usage points associated with a particular usage period (e.g., T3UP for Q2) expire at the end of the associated usage period. If usage periods of a particular type are arranged in a back-to-back manner, when one usage period expires, the next consecutive usage period may start automatically, and usage points associated with that next usage period (e.g., T3UP for Q3) may be used in a similar manner. For non-back-to-back usage periods, the usage periods start according to the associated usage period start time setting and expire according to the type/duration of the usage period. FIG. 2B shows several other examples of usage points of different types expiring at various times, for example, shown at reference numbers 260, 262, 264, 266, 268, 270. In some embodiments, each usage point may also be associated with an absolute expiration date/time, for example, which may be tied to the date/time when the points where purchased. For example, all points may expire 10 years (or some other absolute expiration period) after the date the points are purchased. The absolute expiration period may be a setting, e.g., maintained in market settings repository 126 or 204. In some examples, the market setting repository may maintain a different absolute expiration period for each type/duration of point. If an absolute expiration period is used, each purchased point may be associated with two expiration dates—an expiration date from the associated usage period and an absolute expiration date tied to the date/time of purchase. With the possibility of different usage points that are allocated to a single resource having varying expiration dates, the system may revoke a user's access to the resource when the earliest expiration date of points occurs, assuming the remaining points aren't enough to support usage of the resource.

Based on the previous descriptions, it can be seen that users can purchase points of different types and configure the associated usage periods start times in order to align the usage periods with the user's own relevant time periods (e.g., the user's budgetary or fiscal time periods). For example, the user may purchase a number of quarter-duration points (e.g., 256), and may start these points at an indicated time (e.g., 278). The user may do likewise for other types of points (e.g., half-year-duration points, year-duration points and the like). In this respect, the user may know (e.g., up front) the cost of using resources in the system for the user's relevant time periods (e.g., fiscal quarter, year, etc). The system may provide flexibility to users to manage expenses (e.g., IT or software expenses) over the course of the year. In some scenarios, a user may be able to commit part of the user's budget for a whole year (e.g. buying one-year-duration points). Then, the user may be able to commit some other part of the user's budget for a shorter period of time (e.g. buying quarter-duration points). Then, in the examples where each particular usage period of a certain type has its own start time, even more flexibility may be provided. For example, if projects come up at arbitrary times (e.g., mid-month), the user may buy points, set the start date of a particular shorter-term usage period, and assign the points to that usage period.

Referring again to FIG. 2A, each type of point (e.g., type 1, type 2, etc.) may be priced differently. The resource market system may maintain (e.g., in market settings repository 204) a point price for each type of point. For example, type 1 point price (T1PP) 213 may be the price a user must pay to acquire points that are exchangeable for usage of resources during type 1 usage periods, and likewise for type 2 point price (T2PP) 215. The system may maintain price conversions 216 between the point prices for different types of points. As one example, the point price for each type of point may be related (e.g., by some function, multiplying factor or the like) to the DPP 211. Other conversions schemes may be used as well. Price conversions 216 may take into account other factors as well, beyond just the ratio between point prices for different types of points. For example, other factors may include the start date of points (e.g., from the associated usage period), restrictions on points (described more herein), and other factors. One example benefit of maintaining price conversions may be that the system, at times, may change the DPP, and the prices of the various types of points may change automatically. Another example benefit may be that users may be allowed, under some situations, to exchange points of one type for points of another type. The price conversions may dictate, for example, how many of one type of point may be exchanged for how many of another type of point. It should be understood that while an admin may be able to change various price conversion factors, rates, etc. at times, new price conversions may only effect new transactions/contracts (e.g., new purchases of points) between users and the resource market system.

In some situations, the resource market system may set various point prices (e.g., DPP, T1PP, T2PP, etc.) such that the resource market system may make a profit for the services it provides. For example, the point prices may be increased (e.g., by certain %) beyond what may be required for the providers of resources to be perfectly compensated for use of their resources. In this respect, the resource market system may make a profit based on the purchase of each usage point in the system. In some situations, the resource market system may set the point price for various points such that the point price varies depending on how many points the user purchases. For example, the user could receive a discount if the user purchases several points at the same time. Discounts and bundles of points may be structured in various ways. For example, a user may have to buy a certain number of a certain type of point in order to receive a discount. As another example, the system may offer discounts associated with different mixes or bundles of types of points (e.g., X number of one-year points, Y number of half-year points, and Z number of quarter points, etc.). As another example, the system may offer discounts if users associated their purchased points with usage periods (thereby setting the start date of such points) earlier in time. Specifically, if a user associated purchased points with particular usage periods at the time of purchase the user may receive a discount.

To purchase points, users may view (e.g., see reference number 219) the various usage points/periods (e.g., T1UP, T2UP, etc.) provided by the system and the point prices (e.g., T1PP, T2PP, etc.) associated with these usage points/periods. In this respect, a user may be able to determine the exact amount of money the user will spend to use resources of the system for one or more specified periods of time. Users may select a number of points of each type and may pay for the selected points according to the point prices for the particular type of points. Users may also assign each point to a particular usage period, as described above. By purchasing points, a user (e.g., 202) may cause a count or number of points (e.g., 224, 226) for each type of point to increase in the user's account (e.g., 206). These counts of the number of points of various types may be maintained or tracked in the user's account.

The resource market system may provide flexibility to users regarding when the users purchase points in relation to the progress or timing of particular usage periods. For example, as can be seen in FIG. 2B at reference number 280, a user may purchase points for a particular usage period (e.g., T3UP for Q1, T2UP for half year #1, or T1UP for one year) even though the user is purchasing the points after the start of the usage period. In this situation, the price for these points may be prorated to account for the portion of the usage period that has expired. As another example, as can be seen at reference number 282, a user may purchase points for a usage period (e.g., T3UP for Q3 and/or Q4, or T2UP for half year #2) before the usage period begins. In this example, the price for these points may not be prorated.

The following may describe how the resource market system may determine whether a user may use a particular resource during a particular usage period. A resources repository (e.g., 128) may store or maintain various resources and/or access information for various resources provided by the system. Providers may upload or provide resources and/or access to resources as described in more detail below. The resources repository (e.g., indicated by dotted box 208 in FIG. 2A) may maintain various values and/or settings for each resource, for example, DUCC 230, T1UCC, T2UCC, T1UPC, T2UPC, etc.

Default usage currency cost (DUCC) 230 may refer to the price (e.g., in currency such as dollars) to use a particular resource (e.g., resource 1) for the DUP. This price may be provided by the provider of the resource, as described in more detail below. In alternate embodiments and/or scenarios, this price may be set by the system. In some situations, users, providers and/or admins may be able to browse various resources provided by the system, and DUCC 230 for the various resources may serve as a price that is associated with a fixed benchmark (DUP) such that users, providers and admins may compare prices of various resources in relation to the DUP.

Resources repository 208 may maintain, for each resource, a usage currency cost (e.g., generally indicated by type [ ] usage currency cost or T[ ]UCC) for each type of point offered by the system. For example, FIG. 2A shows a T1UCC 232 and a T2UCC 234. Each type [ ] usage currency cost may refer to the price (e.g., in currency such as dollars) to use the particular resource (e.g., resource 1) for the particular type of point/usage period. Each type [ ] currency cost may be determined by converting DUCC 230 to each type [ ] currency cost. Each conversion may be performed by referencing the market settings repository 204, for example, price conversions 216 or various point prices (e.g., 211, 213, 215) maintained in the market settings repository. As one specific example, T1UCC may be determined by identifying and using the ratio of DPP 211 to T1PP 213.

Resources repository 208 may also maintain, for each resource, a usage points cost (e.g., generally indicated by type [ ] usage points cost or T[ ]UPC) for each type of point offered by the system. For example, FIG. 2A shows a T1UPC 233 and a T2UPC 235. Each type [ ] usage points cost may refer to the points required by the system to be exchanged for use of the resource during a usage period of the same type. The system may determine each type [ ] usage points cost by converting from the associated type [ ] usage currency cost. For example, T1UPC 233 may be determined by converting from T1UCC 232. Each conversion may be performed by referencing the market settings repository 204, for example, price conversions 216 and/or various point prices (e.g., 211, 213, 215) maintained in the market settings repository. As one specific example, T1UCC may be determined by identifying and using the T1PP, which is essentially a ratio of currency (e.g., dollars) to type 1 usage periods.

In some situations, the type [ ] usage points costs may not be determined based on a straight conversion, for example, from T[ ]UCC to T[ ]UPC. In some situations, the resource market system may determine the T[ ]UPC by adding a buffer between the T[ ]UCC and the T[ ]UPC. This may allow the entity that runs the resource market system to make a profit in exchange for the service it is offering. In some situations, alternatively or in addition, a buffer may be added as part of the conversion from DUCC to any of the T[ ]UCC.

At this point, the system may provide, for each resource in the system, a T[ ]UPC for each type of point supported by the system. In other words, each resource may have a price for each type of point (e.g. resource 1 may cost X Type 1 points, Y Type 2 points, etc.).

The resource market system may determine (e.g., as shown by reference number 240 in FIG. 2A) whether a user, given the user's points (e.g., 224, 226, etc.), may use a particular resource (perhaps multiple resources) during a particular usage period. For example, for resource 1 as depicted in FIG. 2A, it may be the case that the user attempts to use resource 1 during a particular T1UP. In order to determine whether the user can use resource 1, the resource market system may analyze the user's points and the T1UPC 233 of resource 1. As can be seen at reference number 240, the user may use resource 1 during the particular T1UP if the user's unallocated type 1 points associated with that particular T1UP is greater than the T1UPC of resource 1. If the user decides to use resource 1, then a number of the user's type 1 points (associated with the particular T1UP) equal (or approximately equal) to the T1UPC for resource 1 will be marked as allocated, and then the user will be allowed access to resource 1. At this point, the user may be allowed to use additional resources (during the particular T1UP) if the user's unallocated points associated with the particular T1UP (e.g., after points have been allocated for usage of resource 1) permit such usage. The resource market system may determine whether the user may use additional resources in a similar manner as just discussed. If the user allocates points to use additional resources, those points may similarly be marked as allocated.

Thus it should be understood that, in general, usage of a resource can only be acquired with points of the same type as the usage period during with the resource will be used. If, for example, a user does not have enough points of a certain type to use a resource during a particular usage period, the user may have to acquire more points of that type. The user may purchase such points and associate them with the usage period as discussed herein. Alternatively, the user may have some inactive points (e.g., not associated with any particular usage period) of another type or some unallocated (and active points) of another type, and the user may be allowed to convert the points of that type into points of the type required, for example, using price conversions (e.g., 216) as discussed in more detail herein.

A user's allocated points may continue to allow the user to use the resources to which the points are allocated until the expiration of the usage period to which the points are associated, or until the user de-allocates the points. If at some point before the expiration of the usage period, the user indicates that the user would like to stop using a resource (e.g., resource 1), the points previously allocated to the resource may be marked as unallocated, and the user may no longer be able to use the resource. At any time, unallocated points may remain unallocated (e.g., ready for future allocation), or they may be reallocated to other resources in the system (e.g., before the end of the associated usage period) to permit usage of the other resources.

In some embodiments and/or scenarios, the resource market system may support and allow for partial usage points. For example, the T1UPC 233, T2UPC 235, etc. may be stored and indicated as a decimal or fractional number (e.g., 4.75 usage points). Such partial usage points may be used, for example, if the conversion from the type [ ] usage currency cost to the type [ ] usage points cost does not result in an integer number. If partial usage points are allowed (e.g., for T1UPC 233, T2UPC 235, etc.), then the user's points (e.g., 224, 226) may be allowed to be used (e.g., to allocate to resources) and stored (e.g., in user account 206) in a similar partial manner. For example, a user may have 10 type 1 usage points (e.g., 224) and may exchange 4.75 of those points for usage of a resource (e.g., because the type 1 usage points cost of the resource is 4.75), resulting in the user only having 5.25 unallocated type 1 usage points. In some embodiments and/or scenarios, integer numbers for points may be maintained, however. In such a case, if the conversion from T[ ]UCC to T[ ]UPC results in a non-integer value, the resource market system may, for example, round the values up (or down) to an integer value. As one specific example, the conversion from T[ ]UCC to T[ ]UPC may include adding a buffer so that the resource market can make a profit. The buffer may be added to the T[ ]UPC, and then the final number may be rounded up to the next integer, for example.

In some embodiments and/or scenarios, various usage points (e.g., 224, 226, etc.) may be associated with usage restrictions. A usage restriction may limit the way a usage point may be used. Various types of usage restrictions may be used by the system and a usage point may be associated with one or more usage restrictions. Moreover, different types of points may be subject to different restrictions. Some usage restrictions may limit the types of resources that the point may be used towards. Specifically, one usage restriction may require that the point be used towards resources of a particular category (e.g., software applications, storage, etc.). Another usage restriction may require that the point be used toward resources with a particular certification (explained in more detail below). Usage restrictions may be associated with points when users purchase the points, and users may be able to see the usage restrictions for particular points before the users purchase the points.

Users may be able to select (e.g., with some limitations) which usage restrictions are associated with their points. Alternatively or in addition, usage restrictions may be imposed by the system (e.g., based on input from an administrator). Users may opt to purchase points with usage restrictions for a variety of reasons. For example, some users may want to protect themselves by only using resources with particular certifications. As another example, points may be priced differently based on the usage restrictions that are associated with the points. If the user's points (e.g., 224, 226) are associated with usage restrictions, then the resource market system may check (e.g., at reference number 240) whether the user's points can be used toward a particular resource when the user attempts to select such a resource for use. Additionally, resource providers may specify restrictions on points that can be used to purchase resources provided by the provider. In such a case, to use the resources of the provider, a user must use points with the specified restrictions.

For each user, the resources to which the user currently has access may be tracked and indicated in the user account repository (e.g., 122 or 206). When a user has “access” to a resource or when a user is authorized to “use” a resource, the resource market system may either allow the user to download and run the resource or may allow a user to access and/or run the resource via an online system (e.g., in the cloud). When access or use is revoked, the user may be unable to access the resource online and/or the user's downloaded copy of the resource may be unable to authenticate and may stop working. In some situations, each users' “usage history” may be tracked or maintained in the user account repository, which may allow the user to look back to see what resources the user has used in the past.

A user may change which resources the user uses within a particular usage period (e.g., perhaps subject to at least one MEP, as discussed below). If the user purchases enough points for a particular usage period, the user may use several resources during that usage period. However, if the user does not have enough unallocated points to use a particular resource during a usage period, the user may de-allocate points from a first resource and allocate those points to a second resource. In such a case, access to the first resource may be revoked and the user may be allowed access to the second resource. Thus, it can be seen that points are reusable during the usage period to which the points are associated. During any particular usage period, a user may use as many resources as the user's points for that usage period will allow, e.g., as shown above in Table 1.

The resource market system may monitor (e.g., for each resource) the usage of that resource by various users. Usage for each resource may be monitored down to a specified granularity referred to as the usage increment (UI). The UI may be described in more detail below.

FIGS. 3A and 3B depict diagrams of how an example resource market system (e.g., 102) may work. Specifically, FIGS. 3A and 3B may depict how such a system may work from a provider's point of view. To aid in providing an easy to understand description, FIG. 3B includes the same key that is depicted in FIGS. 2A and 2B. The terms in the key will be defined in various descriptions provided herein.

FIG. 3A depicts an example provider 302 (e.g., similar to providers 106 of FIG. 1). Provider 302 may be an individual, for example, acting on behalf of an entity such as a company. Provider 302 may provide resources to the resource market system (e.g., 102) and may get paid when any of the various users of the system use the resource. FIG. 3A depicts various boxes that represent values, settings and the like that are maintained by the resource market system. Some of these boxes (e.g., 210, 306, 307) are depicted inside of dotted box 204 (entitled, “Market Settings”), which may indicate the same market settings repository as described in FIG. 2A. Some of these boxes (e.g., 230, 312) are depicted inside of dotted box 208 (entitled, “Resources Repository”), which may indicate the same resources repository as described in FIG. 2A. Some of these boxes (e.g., 316, 318) are depicted inside of dotted box 208 (entitled, “Provider Account”), which may indicate that these boxes are maintained in a provider account repository (e.g., 124).

As shown in FIG. 3A, a market settings repository (e.g., indicated by dotted box 204) may maintain a DUP 210 as explained above. The provider 302 may reference (e.g., see reference number 308) DUP 210, for example, to determine what the provider thinks the provider's resource is worth in relation to the DUP (e.g., a price for use during the DUP). The provider 302 may then specify (e.g., see reference number 310) a cost (e.g., in currency such as dollars) per DUP for use of the provider's resource. This cost may be saved as the default usage currency cost (DUCC) 230 (e.g., the same DUCC as mentioned with regard to FIG. 2A) in the resources repository 208. The DUCC is an amount that the provider requests to be paid by the resource market system for usage of the provider's resource. The DUCC may represent the provider's valuation of their resource in relation to a fixed benchmark (DUP). The DUCC may be private information between the resource provider and the resource market. The provider 302 may be able to change DUCC for the provider's resources at any time; however, such changes may not effect in-progress usage periods of various users.

The resource market may convert the DUCC of each resource to various costs for various types of usage periods/points, for example, as described above with regard to T[ ]UCC and T[ ]UPC of FIG. 2A. While the DUCC may be private information, the T[ ]UCC and T[ ]UPC of various resources may be viewable to any users and/or providers of the market. Resource providers may, for example, view T[ ]UCC and T[ ]UPC for resources of other providers to determine whether the provider's resources are in line with or more/less expensive than other resources.

The market settings repository 204 may maintain at least one minimum exchange period (MEP) 306. The at least one MEP may be used by the resource market system to limit how frequently a user may exchange resources during a usage period. Each MEP may indicate, e.g., for all users, a minimum time period, where the user may only be allowed a single exchange (e.g., a single exchange overall or a single exchange per resource) during that time period. In some embodiments and/or scenarios, the system may maintain a single MEP that may apply for all users, all usage periods and/or all types of resources. In some embodiments and/or scenarios, the system may maintain multiple MEP's. For example, different MEP's may apply to different types of usage periods. As another example, different MEP's may apply to different resources (e.g., different types or categories of resources, resources of different providers, etc.). Then, the ability for a user to make an exchange related to a particular type of resource may be limited by the MEP of that particular type. In the scenario of different MEP's for resources of different providers, the provider may specify the MEP.

FIG. 2B shows an example of one MEP with multiple consecutive, back-to-back MEP periods 284. In this example, the MEP's are aligned with T3UP for Q3. In some examples, each type of usage period may use MEP periods that are aligned with the start of the usage periods. In the example of FIG. 2B, the user may, for example, change which resources the user's type 3 usage points for Q3 are allocated to once per each MEP period. In various examples, the length or duration of the MEP periods may vary. In some examples, the length of the MEP periods may be set as low as the usage increment (UI), as explained more below. Using MEP's may reduce the load on the system that may result from users constantly switching which resources they are using.

Referring again to FIG. 3A, the market settings repository 204 may maintain a usage increment (UI) 307. The UI may be set by a system administrator (e.g., 108) and may be a value that is fixed (e.g., until changed by an admin) for all users and providers. In some embodiments and/or examples, the UI may be set by the resource provider. The resource market system may monitor (e.g., for each resource) the usage of resources by various users. Usage for each resource may be monitored down to a specified granularity that is the usage increment (UI). In some situations, there may be a relationship between the UI and the one or more MEP's (discussed above). For example, each MEP may be a multiple of the UI or may be the same as the UI. The resource market system may convert the DUCC 230 to a usage increment cost (UIC) 312. The UIC for each resource may be saved for later when usage for a particular resource is known. Then, the money due to the provider based on usage of the provider's resource may be calculated using the UIC and the usage statistics for the resource (e.g., a number of UI's).

The resource market system may allow the provider 302 to specify (e.g., see reference number 314) a payment period (PP) 316. In some situations (such as when a provider does not specify a payment period), the system may specify a default payment period. The PP 316 may be maintained or indicated in the provider account repository (e.g., see reference number 304). The PP 316 may be a period of time (e.g., one month, one week, etc.) that indicates when the provider prefers to get paid for usage of resources provided by the provider. The PP 316 may operate in a manner that is similar to the usage periods discussed above, in that the term payment period may be used in a flexible manner to refer to, depending on the context, either the provider-defined PP setting (e.g., 316) or time periods (e.g., reoccurring, consecutive, back-to-back time periods) that conform to the PP setting. The provider account repository may also maintain a provider's balance 318. When the resource market system determines that a provider should be paid for usage of the provider's resource(s), the resource market system may cause more money (e.g., digital indications of money) to be added to the provider's balance 318. The market resource system may offer an interface that allows the provider to withdraw money from the system to some other account.

FIG. 3B shows a time diagram 350 (e.g., for a particular provider 302) that includes four PPs 352, 354, 356, 358 back to back. The time diagram 350 may be oriented on an imaginary x-axis that represents time, such that from the left of the time diagram to the right of the time diagram, time ticks by. Each of PP's 352, 354, 356, 358 may conform to a PP setting for the provider, which may determine the length of PPs, for example.

The following may describe how usage may be monitored for various resources provided by a provider, and how a provider may get paid for such usage in relation to the provider's set PP. For the example of FIG. 3B, it will be assumed that the provider (e.g., 302) provides two resources (resource 1 and resource 2). Usage of these resources by various users may be monitored by the resource market system. The usage of the resources may be monitored at a granularity specified by the UI 307, for example. As one specific example, if the UI is set to one day, and if a single user uses the resource for 3 days, the usage for that resource may be 3 UI's (or just 3 UI). FIG. 3B shows usage indicators 360, 362, 364 of example usages of resource 1 and resource 2 by example users 1, 2 and 3. For example, indicator 360 may show that user 1 used resource 1 from a time associated with the left side of indicator box 360 to a time associated with the right side of indicator box 360. Indicators 362 and 364 show similar usages by users 2 and 3. As it can be seen in FIG. 3B, a user may use a resource for a time that spans more than one PP. Therefore, to determine the usage of a resource for a particular PP, the portion of the usage during a particular PP may be analyzed.

The resource market system may determine at the end of each PP (e.g., 352, 354) how much the provider should get paid for usage during that PP. For example, as shown by reference number 366, at the end of PP 352, the system may determine that the provider should get paid for the usage of resource 1 in the amount of UIC (e.g., 312) times the number of UI for usages 360 and 362 that are associated with PP 352. As another example, as shown by reference number 368, at the end of PP 354, the system may determine that the provider should get paid for the usage of resource 1 in the amount of UIC (e.g., 312) times the number of UI for usages 360 and 362 that are associated with PP 354. Additionally, at the end of PP 354, the system may determine that the provider should get paid for the usage of resource 2 in the amount of UIC (specific to resource 2) times the number of UI for usage 364 that is associated with PP 354. In some situations, the resource market system may alter the amount that the provider gets paid (e.g., at the end of a PP) based on various factors. For example, the amount of money due to a provider may be altered (e.g., on a percentage base or otherwise) based on certifications for the resources (described more below), incentives, rewards and the like. Various types of information may be tracked for resource providers and may be stored or maintained in the provider account repository (e.g., 124), for example, dates and amounts for payments dispersed by the system, usage history for various resources provided by the provider, and the like.

FIG. 4 is a block diagram of an example resource market service 400 for providing resources based on reusable usage points and usage periods. Resource market service 400 may be similar to resource market service 120, for example. Resource market service 400 may facilitate some or all of the calculations, operations, interactions and the like shown in FIGS. 2A, 2B, 3A and 3B. Resource market service 400 may include a user interface 402, which may allow at least one user 403 to interact with the resource market service 400. Resource market service 400 may include a provider interface 404, which may allow at least one provider 405 to interact with the resource market service 400. Resource market service 400 may include a usage monitoring module 406, which may monitor the usage (by various users) of resources provided by the system. Resource market service 400 may include an admin interface 408, which may allow at least one admin 409 to interact with the resource market service 400. Resource market service 400 may include a certification module 426. Resource market service 400 may be in communication with a number of repositories 430, 432, 434, 436, which may be similar to repositories 122,126, 128, 124, respectively. FIG. 4 may show a number of connections represented as arrows. It should be understood that the connections/arrows shown in FIG. 4 are just some example connections and more or less connections may be used in alternate embodiments and/or scenarios.

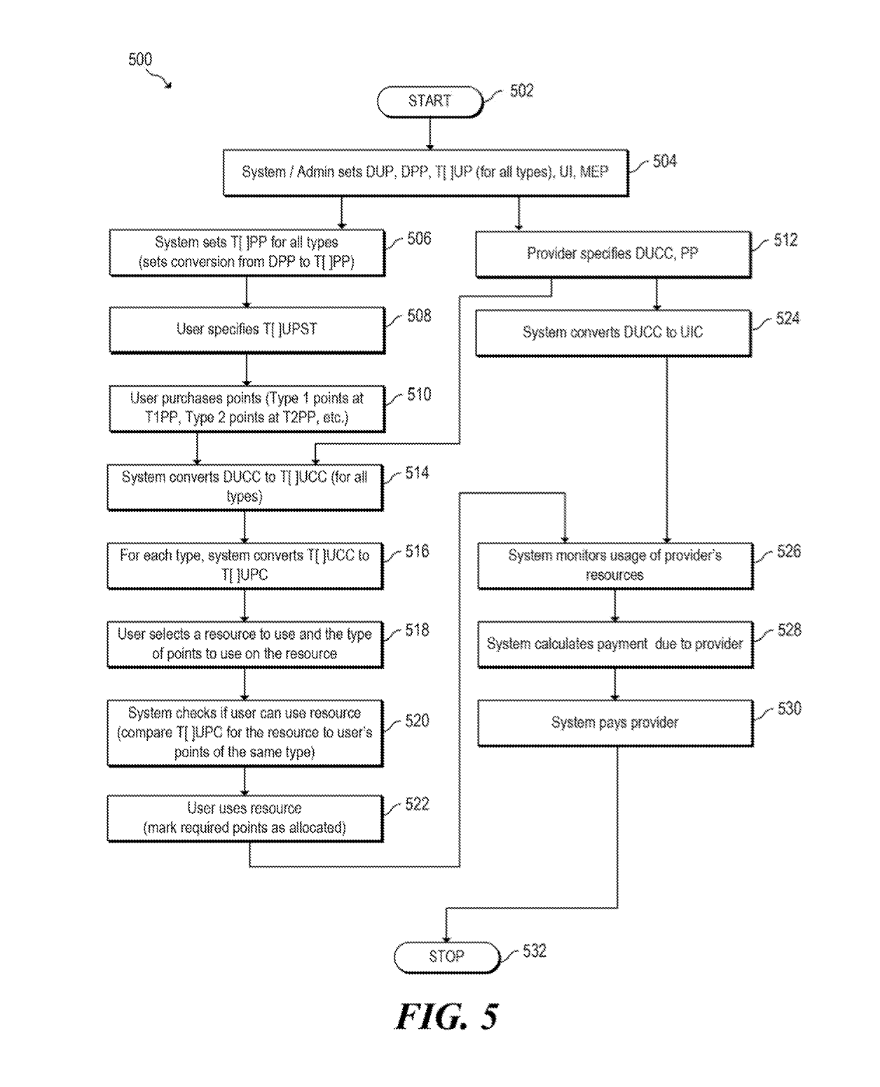

User interface 402 may include a number of modules, for example, modules 410, 412, 414, 416. These modules (and user interface 402 generally) may include a series of instructions encoded on a machine-readable storage medium and executable by a processor (e.g., processor 610 of FIG. 6) accessible by the content market service 400. In addition or as an alternative, these modules (and user interface 402 generally) may include one or more hardware devices including electronic circuitry for implementing the functionality described herein.

User account access module 410 may allow a user 403 to access the user's account (e.g., stored in user account repository 430). For example, a user may set the user's type [ ] usage periods start times (e.g., 220, 222, etc.). As another example, a user may check the number of usage points (e.g., inactive and active, allocated and unallocated) of various types that the user has available to use. Points purchasing module 412 may allow a user 403 to purchase additional points. Module 412 may communicate with market settings repository 432 to determine the price of the points of various types. Module 412 may communicate with user account repository 430 to store an updated indication of the user's points once the user purchases points.

Resource viewing and selection module 414 may allow a user to view resources that are provided by the system and available for use. Module 414 may communicate with resources repository 434 to view resources. Resource viewing and selection module 414 may allow a user 403 to view reviews and/or ratings of resources submitted (e.g., via module 414) by other users. Module 414 may allow a user 403 to view usage statistics (e.g., number of users, number of total hours used, etc.) for various resources. Module 414 may also allow the user to submit reviews and/or ratings of resources that the user has used. Module 414 may also allow the user to view certifications that may have been awarded for each resource. More details regarding certifications may be described below. Resource viewing and selection module 414 may allow a user to view the cost for each resource, for example, DUCC 230, T[ ]UCC (e.g., 232, 234), T[ ]UPC (e.g., 233, 235), etc. Module 414 may allow a user to select a resource for use, provided that the user's points allow for such usage, as described above. For example, the user's unallocated points (of a particular type) for the desired usage period must exceed the usage points cost (for the same type) for the resource. The user's actively usable resources may be tracked or indicated in user account repository 430. The user's resource usage history may also be tracked in repository 430.

Active resources gateway module 416 may allow a user 403 to access (e.g., download or use via the cloud) the user's actively usable resources. Module 416 may communicate with user account repository 430 to determine which resources the user is currently able to access. Module 416 may communicate with resources repository 434 to deliver the resources and/or information needed to access the resources to user 403. Active resources gateway modules 416 may also communicate with usage monitoring module 406 to allow module 406 to monitor the usage of the resources by various users of the system.

Provider interface 404 may include a number of modules, for example, modules 418, 420, 422, 424. These modules (and provider interface 404 generally) may include a series of instructions encoded on a machine-readable storage medium and executable by a processor (e.g., processor 610 of FIG. 6) accessible by the content market service 400. In addition or as an alternative, these modules (and provider interface 404 generally) may include one or more hardware devices including electronic circuitry for implementing the functionality described herein.

Provider account access module 418 may allow a provider 405 to access the provider's account (e.g., stored in provider account repository 436). For example, a provider may set the provider's payment period (PP).

Resource viewing and providing module 420 may allow a provider to provide resources to the system and view resources that are provided by other providers (e.g., in a similar manner to the way users may view resources via module 414). Module 420 may communicate with resources repository 434 to provide and/or view resources. Resource viewing and providing module 420 may allow a provider 405 to view reviews and/or ratings of resources submitted (e.g., via module 414) by various users of the system. Module 420 may allow a provider 405 to view usage statistics (e.g., number of users, number of total hours used, etc.) for various resources. Module 420 may allow a provider to view the usage cost for each resource, for example, in relation to the DUP (DUCC). Module 420 may allow a provider to provide resources for use by users. To provide a resource, the provider may cause a resource (e.g., a software application) to be uploaded to the system (e.g., to the resources repository 434). Alternatively, the provider may provide information (e.g., a URL) that may be used to access the resource. Module 420 may allow a provider to request a certification for at least one of the provider's resources in the system. More details regarding certification may be described below.

Usage cost setting module 422 may allow a provider to set and/or modify the usage cost for the provider's resources in the system. As described above, providers may modify usage costs at any time; however, the changes may not effect in-progress usage periods for various users. For example, a provider may specify (e.g., see reference number 310 in FIG. 3A) a price per DUP (a DUCC) for each resource provided by the provider. Module 422 may communicate with market settings repository 432 to determine the DUP. Usage cost setting module 422 may allow a provider to set an MEP for at least one of the provider's resources. In some situations, a provider may specify different MEP's for different resources of the same provider.

Payment module 424 may allow a provider 405 to get paid for usage of resources provided by the provider. Payment module 424 may receive (e.g., from usage monitoring module 406) usage statistics for various resources in the system. Payment module 424 may communicate with the provider account repository to determine which resources are provided by the particular provider. Payment module may compute the amount that the provider should be paid, for example, for a particular payment period (PP). Payment module 424 may communicate with provider account repository 436 to update (e.g., credit/add to) the provider's balance.

Usage monitoring module 406 may monitor the usage of various resources in the system. Usage monitoring module 406 may include a series of instructions encoded on a machine-readable storage medium and executable by a processor (e.g., processor 610 of FIG. 6) accessible by the resource market service 400. In addition or as an alternative, usage monitoring module 406 may include one or more hardware devices including electronic circuitry for implementing the functionality described herein. Usage monitoring module 406 may communicate with at least one active resources gateway module 416 (e.g., one per user) to receive usage information for various users and/or resources. In some embodiments, module 406 may communicate with resources repository 434 to determine which resources are available and/or to receive information about particular resources. Usage monitoring module 406 may monitor resource usage in a specified granularity (e.g., the UI, as explained in more detail above). Module 406 may provide usage information to at least one payment module 424, for example, one payment module per provider. Module 406 may communicate with resources repository 434 to store usage statistics about particular resources. Such usage statistics may be visible to users and/or providers, for example, via module 414 and/or module 420.

Admin interface 408 may allow an admin 409 to access a market settings repository 432 to add, remove and/or modify various settings and/or values for the resource market service system. For example, module 408 may allow an admin to set and/or modify usage periods (e.g., 210, 212, 214), point prices (e.g., 211, 213, 215), and/or perhaps at least one price conversion 216. Module 408 may allow an admin to set at least one MEP (e.g., 306). Admin interface 408 may include a series of instructions encoded on a machine-readable storage medium and executable by a processor (e.g., processor 610 of FIG. 6) accessible by the content market service 400. In addition or as an alternative, admin interface 408 may include one or more hardware devices including electronic circuitry for implementing the functionality described herein.

Certification module 426 may certify resources provided by the system. Certification module 426 may include a series of instructions encoded on a machine-readable storage medium and executable by a processor (e.g., processor 610 of FIG. 6) accessible by the content market service 400. In addition or as an alternative, certification module 426 may include one or more hardware devices including electronic circuitry for implementing the functionality described herein. Certification module 426 may allow an administrator (e.g., admin 409 via interface 408) to provide a certification for at least one resource provided by the system. In alternate embodiments and/or scenarios, certification module 426 may automatically provide (or deny) certifications, e.g., without input from an administrator. In some embodiments and/or scenarios, module 426 may communicate with an external (e.g., external to the content market system) certification service to provide resource or information about resources to the external service and to receive grants and/or denials of certifications in return.

The term certification or certify may be used to refer to an indication regarding the quality, capabilities and/or safety of a resource. Providers (e.g., 405) may request certifications for their resources in the system, for example, at least one certification for each resource. The resource market service may have gained a reputation as being a trusted resource market, and thus the certifications may convey a trusted indication of resource quality. Likewise, if the certification module 426 communicates with an external certification service, such an external service may be a trusted service. Thus, providers may desire such certifications for their resources and users may prefer resources that are certified.

Certification module 426 may offer various types of certifications that may be available to certify a particular application. For example, different certifications may indicate different levels of performance. As another example, a certification may indicate that a resource is free of bugs, defects, viruses, spyware or the like. In some scenarios, a single resource may have multiple certifications. Certifications received for particular applications may be stored in resources repository 434 and may be visible to users and/or providers (e.g., via module 414 and/or module 420).

Certification module 426 may associate a price or charge with each type of certification. Providers may be required to pay such a price or charge to the resource market service 400 in order to obtain the certification(s). Costs for certifications granted to a particular provider may be subtracted from the provider's balance (e.g., 318). Alternatively, providers may pay for certifications as they are requested or received, or providers may pay for certifications via market entrance fees.

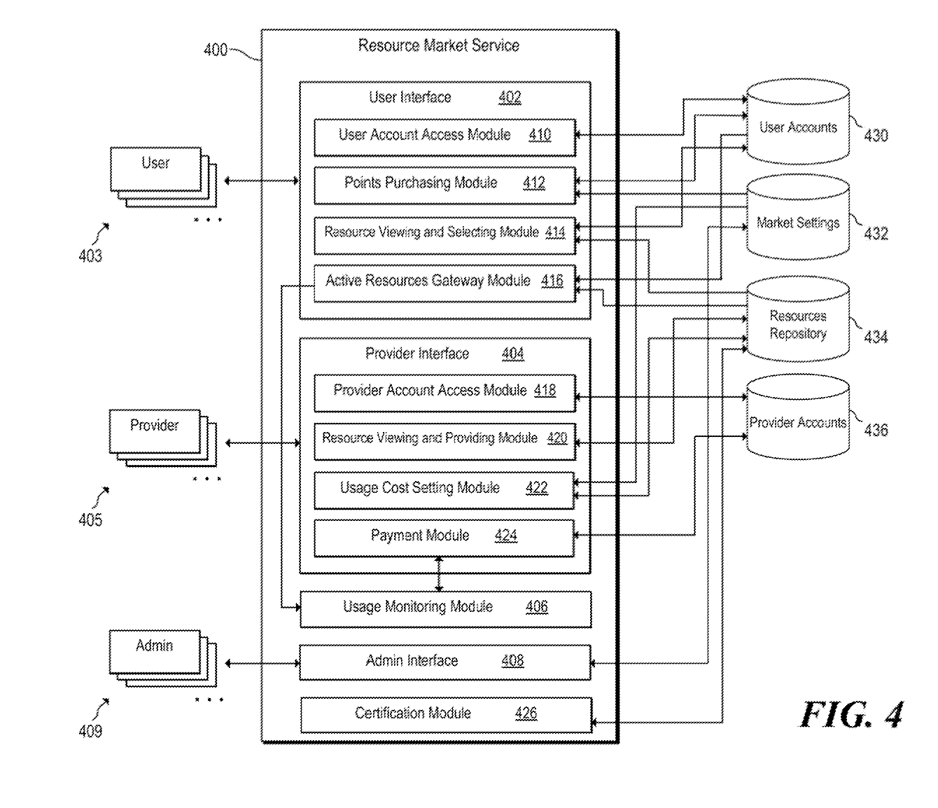

FIG. 5 is a flowchart of an example method 500 for providing resources based on reusable usage points and usage periods. Method 500 may be executed by a resource market system (or simply, system), for example, a system similar to resource market system 102 of FIG. 1. Alternatively, method 500 may be executed by any suitable computing device and/or system, for example, computing device 600 of FIG. 6. Method 500 may be implemented in the form of executable instructions stored on a machine-readable storage medium, such as storage medium 620, and/or in the form of electronic circuitry. In alternate embodiments of the present disclosure, one or more steps of method 500 may be executed substantially concurrently or in a different order than shown in FIG. 5. In alternate embodiments of the present disclosure, method 500 may include more or less steps than are shown in FIG. 5. In some embodiments, one or more of the steps of method 500 may, at certain times, be ongoing and/or may repeat.

Method 500 may start at step 502 and continue to step 504, where the system (e.g., via an administrator via module 408 of FIG. 4) may set various market settings and/or values (e.g., DUP, DPP, T[ ]UP's for all types, UI, MEP, etc.). Such values may be stored in a market settings repository such as 126, 204 or 432. At step 506, the system may set T[ ]PP's for all types of points, for example, based on a conversion from DPP to the T[ ]PP's. At step 508, a user may specify T[ ]UPST's for each type of usage period. It should be understood that, throughout method 500, the actions taken by one user may be similar to the actions taken by other users of the system. At step 510, the user may purchase (e.g., via user interface 402 of FIG. 4) a number of usage points, perhaps of various types. For example, the user may purchase type 1 points at the T1PP (e.g., 213), type 2 points at the T2PP (e.g., 215), etc. At step 512, a provider may specify (e.g., via provider interface 404 of FIG. 4) a DUCC for a particular resource (e.g., resource 1) and a PP, e.g., as indicated above by reference numbers 310, 230, 314 and 316 of FIG. 3A. At step 514, the system may convert DUCC to T[ ]UCC for all point types, e.g., as indicated above by reference numbers 230, 232, 234 of FIG. 2A. At step 516, the system may convert, for each type of point, T[ ]UCC to T[ ]UPC, e.g., as indicated by reference numbers 232, 233, 234 and 235 of FIG. 2A.

At step 518, the user may view and select (e.g., via module 414) a resource to use. At step 520, the system may determine whether the user can use the resource, e.g., as indicated by reference number 240 of FIG. 2A. At step 522, if the system determines that the user can use the resource, the user may have access to the resource and may use the resource. Also at step 522, if the user is able to use the resource and selects to use it, the user's points required to use the resource may be marked as “allocated.” At step 524, the system, for a particular provider's resource, may convert DUCC to UIC, e.g., as indicated by reference numbers 230 and 312 of FIG. 3A. At step 526, the system may monitor (e.g., via module 406) the usage of that resource by various users of the system. At step 528, the system may calculate payment (e.g., via module 424) that is due to the provider as a result of usage of the provider's resources, e.g., as shown by reference numbers 366 and 368 of FIG. 3B. At step 530, the system may pay the provider. Method 500 may eventually continue to step 532, where method 500 may stop.

FIG. 6 is a block diagram of an example resource market computing device 600 for implementing a resource market based on reusable usage points and usage periods. Resource market computing device 600 may be any computing device capable of being accessed by users and providers over the Internet or some other network. In some embodiments, resource market computing device 600 may actually be more than one computing device, in which case, multiple processors and/or machine readable mediums may be involved. More details regarding an example resource market system and/or resource market service may be described above, for example, with respect to resource market system 102 of FIG. 2, resource market service 120 of FIG. 2 and/or resource market service 400 of FIG. 4. In the embodiment of FIG. 6, resource market computing device 600 includes at least one processor 610 and a machine-readable storage medium 620.

Processor 610 may be one or more central processing units (CPUs), CPU cores, microprocessors, and/or other hardware devices suitable for retrieval and execution of instructions stored in a machine-readable storage medium (e.g., 620). Processor 610 may fetch, decode, and execute instructions (e.g., instructions 622, 624, 626, 628) to, among other things, provide resources based on reusable usage points and usage periods. With respect to the executable instruction representations (e.g., boxes) shown in FIG. 6, it should be understood that part or all of the executable instructions included within one box may, in alternate embodiments, be included in a different box shown in the figures or in a different box not shown.

Machine-readable storage medium 620 may be any electronic, magnetic, optical, or other physical storage device that stores executable instructions. Thus, machine-readable storage medium 620 may be, for example, Random Access Memory (RAM), an Electrically-Erasable Programmable Read-Only Memory (EEPROM), a storage drive, an optical disc, and the like. Machine-readable storage medium 620 may be disposed within a computing device (e.g., 600), as shown in FIG. 6. In this situation, the executable instructions may be “installed” on the computing device. Alternatively, machine-readable storage medium 620 may be a portable (e.g., external) storage medium, for example, that allows a computing device (e.g., 600) to remotely execute the instructions or download the instructions from the storage medium. In this situation, the executable instructions may be part of an installation package. As described below, machine-readable storage medium 620 may be encoded with executable instructions to provide resources based on reusable usage points and usage periods.

Resource maintenance instructions 622 may maintain multiple resources provided by at least one resource provider. Each resource being accessible by a user. More details regarding maintaining resources may be described above, for example, with regard to resources repository 128, 208 and/or 434. Usage period maintenance instructions 624 may maintain multiple types of usage periods and multiple usage periods of each type, for example, for each type, multiple consecutive usage periods, during which the user can use at least one resource. More details regarding maintaining usage periods may be described above, for example, with regard to DUP 210, T1UP 212, T2UP 214, etc. Usage points maintenance instructions 626 may maintain, for the user, a number of usage points of various types that may be exchanged by the user for usage of at least one of the multiple resources. Each usage point may be associated with a particular type and with a particular usage period of the same type (e.g., a particular usage period of multiple consecutive usage periods of the same type). Each usage point may be allocable by the user to a particular resource of the multiple resources. More details regarding usage points may be described above, for example, with regard to user's points 224 and 226 of FIG. 2A. Point allocation/reallocation instructions 628 may allocate, de-allocate and/or reallocate points to at least one resource. Instructions 628 may, for example, allow the user to specify or change which particular resource each usage point is allocated to during the usage period associated with the particular usage point.

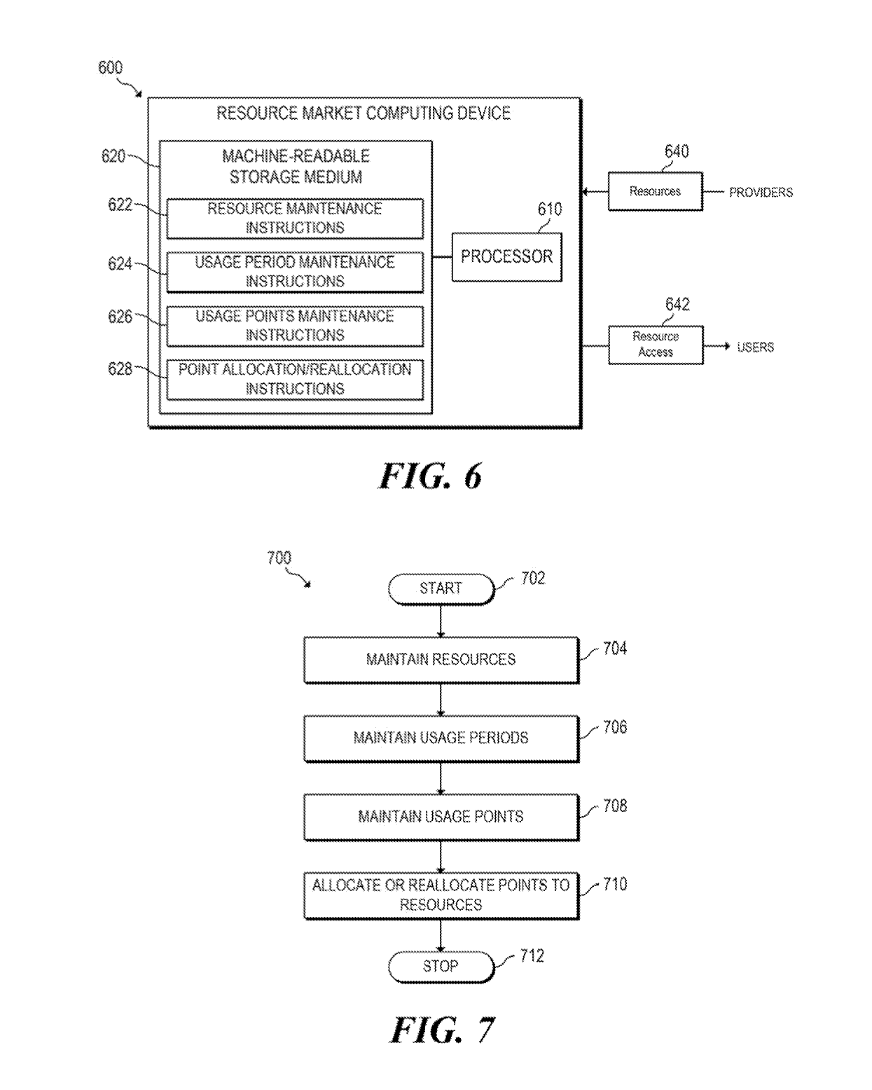

FIG. 7 is a flowchart of an example method 700 for providing resources based on reusable usage points and usage periods. Method 700 may be executed by at least one computing device (e.g., 600) of a resource market system. Method 700 may be executed by other suitable computing devices and/or systems, for example, system 102 of FIG. 1. Method 700 may be implemented in the form of executable instructions stored on a machine-readable storage medium, such as storage medium 620, and/or in the form of electronic circuitry. In alternate embodiments of the present disclosure, one or more steps of method 700 may be executed substantially concurrently or in a different order than shown in FIG. 7. In alternate embodiments of the present disclosure, method 700 may include more or less steps than are shown in FIG. 7. In some embodiments, one or more of the steps of method 700 may, at certain times, be ongoing and/or may repeat.

Method 700 may start at step 702 and continue to step 704, where computing device 600 may maintain (e.g., via instructions 622) multiple resources provided by at least one resource provider. Each resource may be accessible by a user. At step 706, computing device 600 may maintain (e.g., via instructions 624) usage periods (e.g., multiple consecutive usage periods of various types), for example, during which the user can use resources of the multiple resources. At step 708, computing device 600 may maintain (e.g., via instructions 626), for the user, a number of usage points of various types. The usage points may be exchanged by the user for usage of at least one of the multiple resources. Each usage point of a particular type may be associated with a particular usage period of the multiple consecutive usage periods of the same type. Each usage point may be allocable by the user to a particular resource of the multiple resources. At step 710, computing device 600 may allocate, de-allocate and/or reallocate (e.g., via instructions 628) usage points to resources. For example, computing device 600 may allow the user to specify or change which particular resource each usage point is allocated to during the usage period associated with the particular usage point. Method 700 may eventually continue to step 712, where method 700 may stop.

1. A system for a resource market based on reusable usage points and usage periods, the system comprising:
at least one processor to:
maintain multiple resources provided by at least one resource provider, each resource being conditionally accessible by a user;
maintain multiple types of usage periods, each different usage period type specifying a different duration;
maintain multiple types of usage points, the usage point types being respectively associated with the usage period types; and
allow the user to access a first resource of the multiple resources during a particular usage period by allocating a number of usage points to the first resource, wherein the usage is allowed based on the usage period being of a first usage period type of the multiple usage period types and the number of usage points each being of an associated first usage point type of the multiple usage point types.

2. The system of claim 1, wherein the at least one processor is further to:
maintain multiple usage point prices, the usage point prices being respectively associated with the usage point types; and
allow the user to purchase a first number of usage points of the first usage point type by paying for each at an associated first usage point price of the multiple usage point prices.

3. The system of claim 2, wherein the at least one processor is further to allow the user to purchase a second number of usage points of a second usage point type of the multiple usage point types by paying for each at an associated second usage point price of the multiple usage point prices.

4. The system of claim 1, wherein the at least one processor is further to allow the user to assign the number of usage points to the particular usage period, wherein the usage is allowed based on the number of usage points being assigned to the particular usage period.

5. The system of claim 1, wherein the at least one processor is further to maintain, for each resource of the multiple resources, multiple usage costs, the usage costs being respectively associated with the usage period types, wherein, for a particular resource, each usage cost indicates a cost in terms of usage points for a user to use the particular resource during a usage period of the type associated with the usage cost.

6. The system of claim 5, wherein the usage is allowed further based on the number of usage points being greater than a first usage cost of the first resource, wherein the first usage cost is associated with the first usage period type.

7. The system of claim 5, wherein, for each resource, the multiple usage costs are each related to a cost specified by a resource provider of the particular resource.

8. The system of claim 1, wherein the at least one processor is further to maintain, for the user, multiple usage periods start times, the usage periods start times being respectively associated with the multiple types of usage periods, wherein each usage periods start time indicates a date and/or time when usage periods of the associated type begin.

9. The system of claim 1, wherein the at least one processor is further to maintain, for the user, a usage period start time for the particular usage period and usage period start times for multiple other usage periods, wherein each usage period start time indicates a date and/or time when the associated usage period begins.

10. The system of claim 1, wherein the at least one processor is further to determine an amount of money owed to a resource provider of the first resource based on usage, by the user, of the first resource.

11. A method for providing resources based on reusable usage points and usage periods, the method comprising:
maintaining multiple resources provided by at least one resource provider, each resource being conditionally accessible by a user,
maintaining multiple types of usage periods, each different usage period type specifying a different duration;
maintaining multiple types of usage points, the usage point types being respectively associated with the usage period types;
receiving input from the user to purchase a number of usage points, each usage point being associated with one of the multiple types of usage point types;
maintaining, for each resource of the multiple resources, multiple usage costs, the usage costs being respectively associated with the usage period types; and
allowing the user to access a first resource of the multiple resources during a first usage period of a first usage period type by allocating a first usage point of a first usage point type to the first resource, wherein access is allowed based on the first usage period type being associated with the first usage point type and further based on a usage cost of the first resource that is related to the first usage period type.

12. The method of claim 11, further comprising, during the first usage period:
allowing the user to de-allocate the first usage point from the first resource thereby causing access to the first resource by the user to be revoked;
allowing the user to leave the first usage point as unallocated for a period of time; and
allowing the user to allocate the first usage point to a second resource thereby allowing the user to access the second resource.

13. The method of claim 11, further comprising, allowing the user to access a second resource of the multiple resources during the first usage period of a first usage period type by allocating a second usage point of the first usage point type to the second resource.

14. The method of claim 11, wherein the multiple types of usage periods and multiple types of usage points are set by an administrator of a system that performs the method.

15. A machine-readable storage medium encoded with instructions executable by at least one processor of a system for providing resources based on reusable usage points and usage periods, the machine-readable storage medium comprising:
instructions to maintain multiple resources provided by at least one resource provider, each resource being conditionally accessible by a user;
instructions to maintain multiple types of usage periods, each different usage period type specifying a different duration;
instructions to maintain multiple types of usage points, the usage point types being respectively associated with the usage period types; and
instructions to allow the user to access a first resource of the multiple resources during a particular usage period by allocating a number of usage points to the first resource, wherein the particular usage period is of a usage period type that is associated with a usage point type of the number of usage points.

16. The machine-readable storage medium of claim 15, further comprising instructions to convert between the multiple types of usage points.

17. The machine-readable storage medium of claim 15, further comprising:
instructions to allow a first resource provider of the at least one resource provider to request certification of a first resource of the multiple resources;
instructions to associate a certification with the first resource in response to the first resource provider requesting certification; and
instructions to display to the user the certification while the user is viewing a representation of the multiple resources maintained by the system.

18. The machine-readable storage medium of claim 15, further comprising instructions to monitor, for each resource of the multiple resources, usage of or access to the resource by the user and other users, wherein usage is monitored according to usage increments that each have a duration that is less than the duration associated with any one of the multiple types of usage periods.

19. The machine-readable storage medium of claim 15, further comprising:
instructions to allow the user to de-allocate a usage point from the first resource thereby causing access to the first resource by the user to be revoked;
instructions to allow the user to leave the usage point as unallocated for a period of time; and
instructions to allow the user to allocate the usage point to a second resource thereby allowing the user to access the second resource.
